(19) United States
(12) Patent Application Publication
(10) Pub. No.: US 2005/0087430 A1
(43) Pub. Date: Apr. 28, 2005

(54) Electric power circuit breaker comprising a connection device for auxiliary current circuits

(76) Inventors: Bernd Ette, Monchwinkel (DE); Holger Hochgraef, Berghausen (DE); Jeffery C. Mizener, Sidney, OH (US); Aron-Ernst Musiol, Mahlow (DE)

Correspondence Address: HARNESS, DICKEY & PIERCE, P.L.C., P.O.BOX 8910, RESTON, VA, 20195, US

(21) Appl. No.: 10/494,459

(22) PCT Filed: Oct. 18, 2002
(86) PCT No.: PCT/DE02/04004

(30) Foreign Application Priority Data
Oct. 31, 2001 (DE) 101 54 980.6

(51) Int. Cl. H01H 9/20

(52) U.S. Cl. 200/50.01

(57) ABSTRACT

A power circuit breaker includes break contacts for main current circuits and a connection device for auxiliary current circuits that interacts with a contact device mounted in a fixed manner. Signaling switches are placed on a withdrawable rack, which accommodates the power circuit breaker, and are provided for detecting and signaling the position of the power circuit breaker located inside said withdrawbable rack. The signaling switches are structurally assigned in a direct manner to an interface subassembly that processes signals, which are transmitted out of the contact device and by the signaling switches and to be relayed to a field bus system.

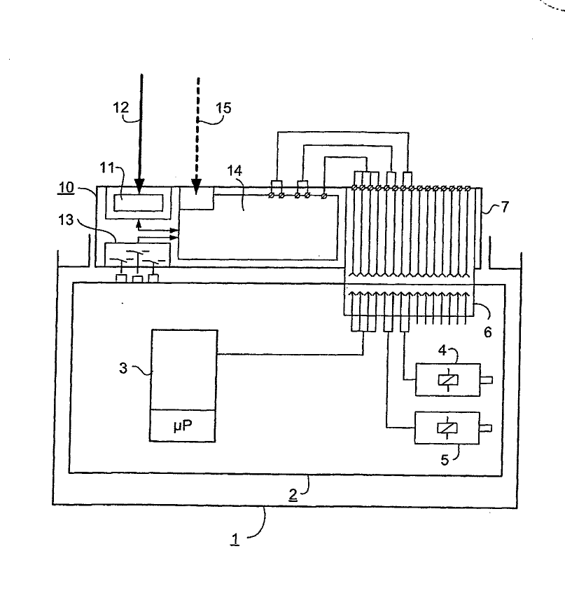

This application is the national phase under 35 U.S.C. § 371 of PCT International Application No. PCT/DE02/04004 which has an International filing date of Oct. 18, 2002, which designated the United States of America and which claims priority on German Patent Application number DE 101 54 980.6 filed Oct. 31, 2001, the entire contents of which is hereby incorporated herein by reference.

### FIELD OF THE INVENTION

The invention generally relates to an electrical power breaker having isolating contacts for main circuits, a connection device for auxiliary circuits, and having a contact device which interacts with the connection device and is fitted such that it is fixed in position. It is possible for the power breaker to assume, in relation to the isolating contacts, an operating position and an isolating position as well as a test position located between these two positions. Further, the connection device for auxiliary circuits may be connected to the stationary contact device in the operating position and in the test position. In addition, signaling switches may be included for detecting and signaling the positions of the power breaker in a withdrawable-part frame and an interface module may be arranged on the withdrawable-part frame accommodating the power breaker. The interface module may further process signals from the contact device which have been transmitted by the signaling switches for the purpose of passing them on to a fieldbus system.

### BACKGROUND OF THE INVENTION

Withdrawable power breakers (or drawout power breakers) are normally used in conjunction with withdrawable-part frames which are in the form of mounts for stationary isolating contacts and the stationary contact device. Examples of such arrangements are described in U.S. Pat. No. 4,139,748, U.S. Pat. No. 4,743,715 and U.S. Pat. No. 5,594,221. The contact device is used to transmit a large number of signals, both from the moveable power breaker to the withdrawable-part frame and vice versa.

A particularly important factor here is signaling of the position of the power breaker in the withdrawable-part frame (operating position, test position, isolating position), in order to be able to monitor the switching state and the operational availability of the power breakers of a switchgear assembly by way of a central control desk.

In order to detect the position of the power breaker, special, robust and particularly operationally reliable modules of signaling switches are used, for example according to DE 201 05 889 U1. This signaling or auxiliary switch module is located on a side wall of a withdrawable-part frame and is actuated by a power breaker located in the withdrawable-part frame. It is therefore also possible to detect the state in which there is no power breaker in the withdrawable-part frame.

For the purpose of transferring control signals between a central control device and the power breakers of a switchgear assembly, it is known, in order to avoid the need for complete individual wiring using numerous conductors, to use so-called fieldbus systems which in the simplest case require only four cables (two signal cables, two cables for the power supply), irrespective of the number of switching devices to be connected. Examples of applications for fieldbus systems are described in DE 197 06 961 A1 or EP 0 736 946 B1.

In such a fieldbus system, on the one hand, messages and commands therefore need to be fed in between the protective module (electronic overcurrent release) and a control desk or control center as well as the messages indicating the position of the power breaker in the withdrawable-part frame. However, since the exchange of all information takes place via an interface module (gateway), this means that, at least within the withdrawable-part frame/power breaker module, the interface module needs to be connected to the protective module and the signaling switch module by way of direct (1:1) wiring, as is described in EP 0 923 175 A1.

In this case, the signaling switches are located on the inner side (facing the power breaker) of a side wall of the withdrawable-part frame, whereas the interface module is fitted to the opposite outer side. Common fastening devices for the signaling switches and the interface module pass through the side wall.

### SUMMARY OF THE INVENTION

An embodiment of the invention includes an object of reducing the complexity for wiring and fastening the described components. In the process, it further preferably make compact physical dimensions possible.

According to an embodiment of the invention, an object may be achieved by the contact device, the interface module and the signaling switches being combined to form one assembly. This reduces the amount of wiring such that it no longer has any effect on the physical dimensions. As a result of this, the amount of material used is also reduced and the operational reliability is increased. In this case, conventional wiring can be dispensed with entirely since, for example, a single printed circuit board may at the same time be the mount for the interface module, the contact device and the signaling switches.

### BRIEF DESCRIPTION OF THE DRAWINGS

Further advantages, features and details of the invention will become evident from the description of illustrated exemplary embodiments given hereinbelow and the accompanying drawings, which are given by way of illustration only and thus are not limitative of the present invention, wherein:

The FIGURE shows, schematically, the interacting modules of the power breaker and of the withdrawable-part frame in conjunction with a fieldbus system.

### DETAILED DESCRIPTION OF THE PREFERRED EMBODIMENTS

The FIGURE shows, as interacting units, a withdrawable-part frame or rack 1 having a low-voltage power breaker 2 inserted in it. Details on the design of these units are unimportant in this context, for which reason more detailed descriptions are not provided. Mention is merely made of the fact that a withdrawable-part frame is described in DE 201 05 889 U1, and that suitably designed low-voltage power breakers are also known to those skilled in the art.

The FIGURE shows an electronic overcurrent release 3 belonging to the power breaker 2, an actuating magnet 4 for disconnection purposes and a further actuating magnet 5 for the purpose of connecting the power breaker 2.

In a known manner, the actuating magnets 4 and 5 ensure the release of latching parts in the switching mechanism of the power breaker in order to allow the desired switching operations to take place. The units (the electronic overcurrent release 3, the actuating magnets 4 and 5) are connected to a connection device 6 which is fitted in a known manner to the power breaker 2 such that it can engage with a contact device 7 located on the withdrawable-part frame 1. This contact device 7 belongs to an assembly 10 having connection device(s) 11 for a fieldbus system 12 (profibus, interbus, etc.), which acts as the communication between two or more units of the type shown and with a control center or desk.

The assembly 10 also contains a signaling switch module 13 for detecting the presence of a power breaker 2 in the withdrawable-part frame 1 and the respective position (isolating, test or operating position). An interface module 14 which also belongs to the assembly 10, links the contact device 7, the signaling switch module 13 and the fieldbus system 12. Since the modules are arranged physically very close to one another, there is no need for separate wiring, as was previously necessary.

A dashed arrow indicates that the interface module 14 can also receive and process further signals, for example from other identical or similar assemblies, which are transmitted via a communication system 15. Furthermore, connections between the contact device 7 and the interface module 14 indicate that the overcurrent release 3 and the actuating magnets 4 and 5 can be influenced both by way of the fieldbus system 12 and by wy of the communication system 15. This makes it possible, for example, for the power breaker to be connected or disconnected by remote control or for response values of the overcurrent release 3 to be altered. In this case, the message, which was in each case previously transmitted, indicating the position of the power breaker 2 (not present or present and in isolating/test/operating position) ensures that only commands which can be carried out are transmitted, or commands are only transmitted if the operating state of the power breaker allows the commands to be processed.

The illustration in the FIGURE has been simplified with respect to the contact device 7 insofar as the number of individual contact points is limited to the channels required for understanding the embodiment(s) of the invention. In practice, low-voltage power breakers may have a very large number of contact points in the contact device, which in the context of the embodiment(s) of the invention may also be part of the assembly 10.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An electrical power circuit breaker, comprising:
isolating contacts for at least one main circuit;
a connection device for at least one auxiliary circuit;
a contact device, adapted to interact with the connection device and fitted such that it is fixed in position, wherein in relation to the isolating contacts, an operating position, an isolating position and a test position located between the operating and isolating positions, are each assumable by the power circuit breaker, wherein the connection device is connected to a stationary contact device in the operating position and in the test position;
signaling switches, for detecting and signaling a position of the power circuit breaker in a withdrawable-part frame; and
an interface module arranged on the withdrawable-part frame accommodating the power circuit breaker, said interface module processing signals from the contact device, transmitted by the signaling switches, for passage on to a fieldbus system, wherein the contact device, the interface module and the signaling switches are combined to form one assembly.

2. An electrical power circuit breaker, comprising:
a contact device;
signaling switches, adapted to detect a position of the power circuit breaker; and
an interface module, arranged on a withdrawable-part frame accommodating the power circuit breaker, said interface module being adapted to process signals indicating a detected position for passage on to a fieldbus system, wherein the contact device, the interface module and the signaling switches are combined to form one assembly.

3. The electrical power circuit breaker of claim 2, wherein an operating position, an isolating position and a test position between the operating and isolating positions, are each detectable positions assumable by the power circuit breaker.

4. The electrical power circuit breaker of claim 2, wherein the connection device is connected to a stationary contact device in the operating position and in the test position.

5. The electrical power circuit breaker of claim 3, wherein the connection device is connected to a stationary contact device in the operating position and in the test position.

6. An electrical power circuit breaker, comprising:
a contact device;
switch means for detecting a position of the power circuit breaker; and
means, arranged on a withdrawable-part frame accommodating the power circuit breaker, for processing detected position signals for passage on to a fieldbus system, wherein the contact device, the interface module and the signaling switches are combined to form one assembly.

7. The electrical power circuit breaker of claim 6, wherein an operating position, an isolating position and a test position between the operating and isolating positions, are each detectable positions assumable by the power circuit breaker.

8. The electrical power circuit breaker of claim 6, wherein the connection device is connected to a stationary contact device in the operating position and in the test position.

9. The electrical power circuit breaker of claim 7, wherein the connection device is connected to a stationary contact device in the operating position and in the test position.
